(19) United States
(12) Patent Application Publication
(10) Pub. No.: US 2009/0195677 A1
(43) Pub. Date: Aug. 6, 2009

(54) METHOD AND APPARATUS FOR STORING LOCATION ADDRESS OF DEFECTIVE PIXEL

(76) Inventor: Yo-Hwan Noh, Gyeonggi-do (KR)

Correspondence Address: BIRCH STEWART KOLASCH & BIRCH, PO BOX 747, FALLS CHURCH, VA, 22040-0747, US

(21) Appl. No.: 12/299,958

(22) PCT Filed: May 11, 2007
(86) PCT No.: PCT/KR2007/002349

§ 371 Date: Nov. 7, 2008

(30) Foreign Application Priority Data
May 12, 2006 (KR) 10-2006-0042919

(51) Int. Cl. H04N 5/228

(52) U.S. Cl. 348/247; 348/E05.031

(57) ABSTRACT

A method and apparatus for storing a location address of a defective pixel are disclosed. The method for storing a location address of a defective pixel includes (a) partitioning the pixel array into windows in a predetermined quantity of n, n being a natural number; (b) determining whether successively inputted pixel data is a defective pixel; (c) storing a count value of pertinent pixel data on a window corresponding to the defective pixel as the location address if the inputted pixel data is a defective pixel; and (d) repeating the steps (b) and (c) whenever pixel data corresponding to the pixel array is inputted. With the present invention, the location address can be efficiently stored.

### CROSS-REFERENCE TO RELATED APPLICATIONS

This application claims foreign priority benefits under 35 U.S.C. sctn. 119(a)-(d) to PCT/KR2007/002349, filed May 11, 2007, which is hereby incorporated by reference in its entirety.

### BACKGROUND

1. Technical Field

The present invention relates to a method and apparatus for storing a location address of a defective pixel, more specifically to a method and apparatus that can efficiently store a location address of a defective pixel showing fixed-pattern noise and make it easy to compensate the defective pixel.

2. Description of the Related Art

While most cameras were analog types in the past, today's development of digital processing technologies and high pixel-integration of an image sensor have made digital cameras quickly popularized.

The digital camera converts a light signal of a photographic subject into a digital signal to process the converted signal, for which an image sensor is one of the most necessary elements. Today's image sensors usually employ a charge coupled device (CCD) or a complementary metal oxide semiconductor (CMOS).

The CCD has a common output structure converting a charge accumulated in each pixel into a voltage and buffering the converted voltage to send it to the outside, and the CMOS makes as many metal oxide semiconductors as the number of pixels. Each pixel performs the charge-voltage conversion by using the metal oxide semiconductors.

While the CCD can display a video having clear quality and little noise and display minute details and delicate colors, it is expensive and has complex peripheral circuits. It is also impossible to be realized in a single chip with a peripheral IC.

In the meantime, the CMOS consumes less power for operation than the CCD and has a simple driving method. Besides, as the CMOS can allow a signal processing circuit to be integrated in one chip, the CMOS is often used for a small sized digital camera device.

The CCD and CMOS capture an image by accumulating incident light from a photographic subject in each pixel as an electrical signal (charge) through photoelectric transforming means such as a photodiode and by transforming and outputting the accumulated signal into a digital signal. Due to a foreign material and an unstable factor in the manufacturing process of the image sensor, there can be a defect in a specific pixel. The defective pixel can generate fixed-pattern noise.

The defective pixel can have three types, including stuck high, stuck low, and abnormal response. The stuck high pixel always has a high luminance value for a particular luminosity. The noise generated by the stuck high pixel is referred to as white noise.

In case that the luminance value of a pixel is between 0 and 255 and the luminance value is 25 if it is captured by a normal functional pixel, for example, the stuck high pixel always has a high luminance value, for example, 255.

The stuck low pixel always has a low luminance value for a particular luminosity. The noise generated by the stuck low pixel is referred to as black noise.

For example, in the case of the luminance value of a pixel in the aforementioned range, although the luminance value is 100 or 200 for a normal functional pixel, the stuck low pixel outputs a low luminance value, for example, 5.

The abnormal response pixel has a relatively changed value in comparison with a normal pixel. For example, assuming that the normal luminance value is A, the abnormal response pixel responds with 1.25 A instead of A.

As described above, since there can be various types of defective pixels in the manufacturing process of the image sensor, the image processing apparatus typically detects the defective pixel and appropriately compensates the detected defective pixel.

For the compensation of a defective pixel, a location address of the pixel, determined as having a defect is stored. In case that a defective pixel is on a pixel array, as illustrated in FIG. 1, the conventional art stores an address location of the defective pixel by counting the pixel array horizontally and vertically followed by storing the two count values.

However, in the conventional method, the more the pixel number of the pixel array is, the more bits of the location address are necessary in the memory, overloading the hardware resource.

Moreover, the number of defective pixels can be gradually increased as the number of unit pixels included in an image sensor is increased in order to improve the video quality. To detect and compensate the defective pixel in the conventional art, all of the horizontal and vertical count values are stored in order to store the location address of the defective pixel. This caused an increase in the memory space occupied by the location address, increasing the manufacturing cost. Beside, it takes a lot of time to compare a previously stored location address with the count values of the currently received pixel data for the compensation of the defective pixel.

### SUMMARY

The present invention, which is contrived to solve the aforementioned problems, provides a method and apparatus for storing a location address of a defective pixel that can effectively store a location address of a pixel determined as having a defect.

The present invention provides a method and apparatus for storing a location address of a defective pixel that can decrease a memory space for storing a location address of a defective pixel.

The present invention provides a method and apparatus for storing a location address of a defective pixel that can increase a compensation processing speed by easily identifying a location of a defective pixel when the defective pixel is compensated.

Other problems that the present invention solves will become more apparent through the following description.

To solve the above problems, an aspect of the present invention features a method for storing a location address of a defective pixel of a pixel array disposed with a plurality of unit pixels, including (a) partitioning the pixel array into windows in a predetermined quantity of n, n being a natural number; (b) determining whether successively inputted pixel data is a defective pixel; (c) storing a count value of pertinent pixel data on a window corresponding to the defective pixel as the location address if the inputted pixel data is a defective pixel; and (d) repeating the steps (b) and (c) whenever pixel data corresponding to the pixel array is inputted, whereas the count value of the pixel data after the location address of the defective pixel is stored is initialized.

Preferably, the number of storage memories of a location address of a defective pixel for each of the windows is pre-allotted. Here, the storing size of the location address can be set to the maximum for a window having a center pixel of the pixel array.

In accordance with the present invention, a count value corresponding to the successively inputted pixel data in a pertinent window can be generated by using each independent counter for horizontally disposed windows in a quantity of k, k being a natural number, among the windows in a quantity of n.

At this time, the method further includes performing the counting by using a first counter corresponding to a first window; and performing the counting by using a second counter corresponding to a second window if pixel data included in the second window is received, whereas the first counter memorizes a last count value

Preferably, the first counter starts the counting from a previously memorized count value if the pixel data included in the first window is received again.

Preferably, the windows in a quantity of n share a single counter if the windows in a quantity of n are disposed in a vertical direction. In this case, the method can further include counting the receiving of pixel data included in a first window by using the counter; and initializing the counter and starting the counting if pixel data included in a second window is received.

Preferably, the count value can be generated by using a ring counter.

Also, preferably, the defective pixel can be determined by comparing received pixel data with a predetermined threshold.

At this time, if white noise is removed, the threshold can be an upper threshold, and the defective pixel can be determined by comparing whether the received pixel data is greater than the upper threshold. If black noise is removed, the threshold can be a lower threshold, and the defective pixel can be determined by comparing whether the received pixel data is smaller than the lower threshold.

In accordance with the present invention, preferably, the number of stored location addresses allotted for the entire windows is between 2⁸ and 2¹⁶.

Another aspect of the present invention features a recorded medium tangibly embodying a program of instructions executable by a digital processing apparatus to store a location address of a defective pixel, the recorded medium being readable by the digital processing apparatus, including (a) partitioning a pixel array into windows in a predetermined quantity of n, n being a natural number; (b) determining whether successively inputted pixel data is a defective pixel; (c) storing a count value of pertinent pixel data on a window corresponding to the defective pixel as the location address if the inputted pixel data is a defective pixel; and (d) repeating the steps (b) and (c) whenever pixel data corresponding to the pixel array is inputted, whereas the count value of the pixel data after the location address of the defective pixel is stored is initialized.

Another aspect of the present invention features a processor for storing a location address of a defective pixel of a pixel array disposed with a plurality of unit pixels, including a window generating unit, partitioning the plurality of unit pixels into windows in a predetermined quantity of n, n being a natural number; counters in a quantity of j, independently counting pixel data successively inputted from the pixel array for each window, j being a natural number and 1=j=n; and an address register, storing a count value of pertinent pixel data on a window corresponding to the defective pixel if the successively inputted pixel data is a defective pixel, whereas the counter is initialized if the location address of the defective pixel included in the window is stored.

Another aspect of the present invention features an image processor having a pixel array disposed with a plurality of unit pixels, including an image sensor, having a pixel array disposed with a plurality of unit pixels; a defective pixel detecting unit, detecting a defective pixel by using pixel data successively inputted from the image sensor; an address storing unit, partitioning the pixel array into windows in a predetermined quantity of n, n being a natural number, storing a count value of pertinent pixel data on a window corresponding to a defective pixel as a location address if the successively inputted pixel data is the defective pixel, and initializing the count value after storing the location address of the defective pixel; and a defective pixel compensating unit, compensating pixel data of the defective pixel based on the stored location address.

### BRIEF DESCRIPTION OF THE DRAWINGS

FIG. 1 illustrates a location of a defective pixel in a typical pixel array;

FIG. 2 is a block diagram illustrating an image processing apparatus in accordance with an embodiment of the present invention;

FIG. 3 is a block diagram illustrating an internal structure of an image sensor in accordance with an embodiment of the present invention;

FIG. 4 is a detailed block diagram illustrating a defective pixel detecting unit in accordance with an embodiment of the present invention;

FIG. 5 is a block diagram illustrating a location address storing unit in accordance with an embodiment of the present invention;

FIG. 6 through FIG. 9 illustrate various types of windows generated in accordance with the present invention;

FIG. 10 illustrates a process for counting a specific window in accordance with the present invention;

FIG. 11 illustrates a process for storing a location address of a defective pixel in accordance with the present invention;

FIG. 12 is a flow chart illustrating a process for storing a location address of a defective pixel in accordance with the present invention;

FIG. 13 is a flow chart illustrating a counting process when a window is changed in accordance with an embodiment of the present invention;

FIG. 14 is a flow chart illustrating a counting process when a window is changed in accordance with another embodiment of the present invention; and

FIG. 15 is a flow chart illustrating a process of compensating a defective pixel in accordance with the present invention.

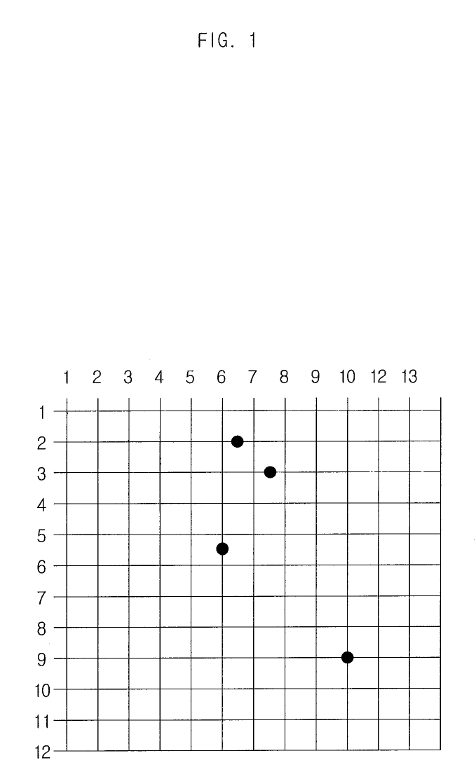

### DETAILED DESCRIPTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof and shall not be construed to preclude any presence or possibility of one or more other characteristics, numbers, steps, operations, elements, pails or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

The present invention stores a location address of a pixel determined as having a defect by using bit numbers smaller than location values according to horizontal and vertical directions in a pixel array of an image sensor. When the defective pixel is compensated, the present invention also provides a method for easily recognizing the location address of the defective pixel. The present invention will be able to be applied to a digital camera and a portable device, having an image sensor, without restriction.

In the meantime, the present invention can realize the method by using an image processing apparatus, mounted on a processor having a program module for storing a location address. Alternatively, the method can be realized by software through a predetermined application program.

In addition, the method suggested by the present invention can be embodied in various forms. Any person of ordinary skill in the art must understand that simple permutations of these kinds of embodiments pertain to the present invention.

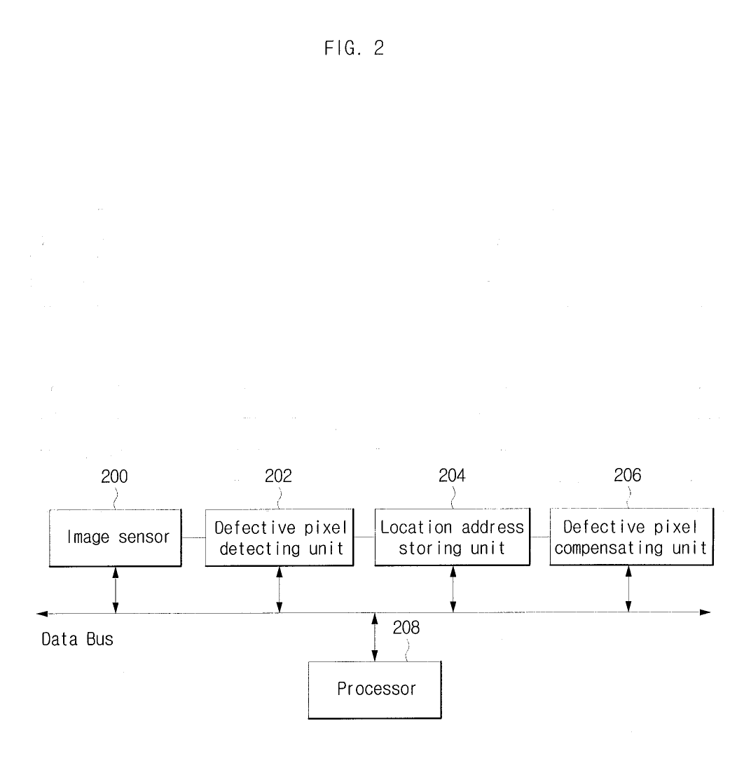

FIG. 2 is a block diagram illustrating an image processing apparatus in accordance with an embodiment of the present invention.

As illustrated in FIG. 2, the image processing apparatus of the present invention can include an image sensor 200, a defective pixel detecting unit 202, a location address storing unit 204, a defective pixel compensating unit 206 and a processor 208.

The image sensor 200 includes a pixel array, disposed with a plurality of unit pixels according to its row and column, like a CCD sensor and a CMOS sensor. Each unit pixel includes a photoelectric transformation element (e.g. a photodiode) transforming a light signal of a photographic subject into an electric signal and outputting the converted signal.

The plurality of unit pixels are successively or collectively disclosed to light according to a predetermined driving signal. When the plurality of unit pixels are disclosed to light, they transforms the received light signal into the electric signal (pixel data) and outputs the converted electric signal successively according to a pixel line.

Here, since the unit pixel receives light through a color filter array disposed in a pattern predetermined with RGB components, the electric signal transformed by the each unit pixel can be one of the RGB components.

The image sensor 200 outputs pixel data of each pixel in the order of pixel line, that is, in the order of column in a specific row of the pixel, and the defective pixel detecting unit 202 receives the pixel data outputted from the image sensor 200.

The defective pixel detecting unit 202 receives pixel data and compares the received pixel data with a predetermined threshold.

Here, the threshold, which is the reference value for determining a defective pixel, can be a predetermined reference clamp value.

As described above, the noise according to the defective pixel can include white noise and black noise. If the white noise is detected, the threshold is an upper threshold. If the image sensor 200 captures and outputs an image related to the photographic subject in low luminous intensity (preferably, all black status), the defective pixel detecting unit 202 determines whether the received pixel data is the defective pixel, by checking whether the pixel data is higher than the upper threshold.

If the black noise is detected, the threshold can be a lower threshold. If the image sensor 200 captures and outputs an image related to the photographic subject in high luminous intensity preferably, all white status), the defective pixel detecting unit 202 determines whether the received pixel data is the defective data, by checking whether the pixel data is smaller than the upper threshold.

To compensate a pixel determined as having a defect by the defective pixel detecting unit 202, it is necessary to store the location address of the defective pixel.

The conventional art stores a location address by using count values in horizontal and vertical directions of the defective pixel. However, in accordance with an embodiment of the present invention, the location address of the defective pixel is stored as order information in each window, not count values in horizontal and vertical directions, by generating a window and counting the receiving of pixel data included in the window independently per each window.

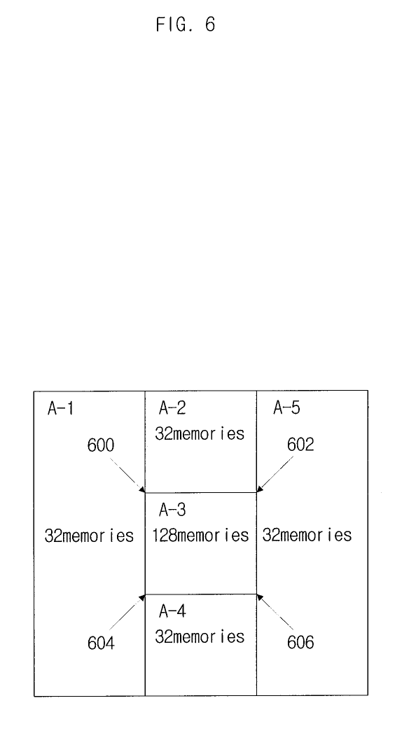

In accordance with the present invention, in the case of receiving pixel data from the image sensor 200, the location address storing unit 204, as illustrated in FIG. 6 through FIG. 9, partitions the pixel array into n windows, n being a predetermined natural number.

Also, the location address storing unit 204 of the present invention generates a count value of the pixel data, outputted from the defective pixel detecting unit 202, through a counter.

In accordance with the present invention, the aforementioned counting process is preferably performed independently of each window. The count is preferably performed by using a ring counter.

Here, the ring counter circulates identical binary numbers inside a shift register as long as a clock pulse is provided, by re-inputting an output of the shift register. The counter is not necessarily limited to the ring counter. Alternatively, the counter can include all counters capable of counting, such as an asynchronous counter and a synchronous counter.

In case that the defective pixel detecting unit 202 determines a specific pixel at its row and column as having a defect in the counting process, the location address storing unit 204 stores a count value of pertinent pixel data of a window corresponding to the defective pixel as a location address.

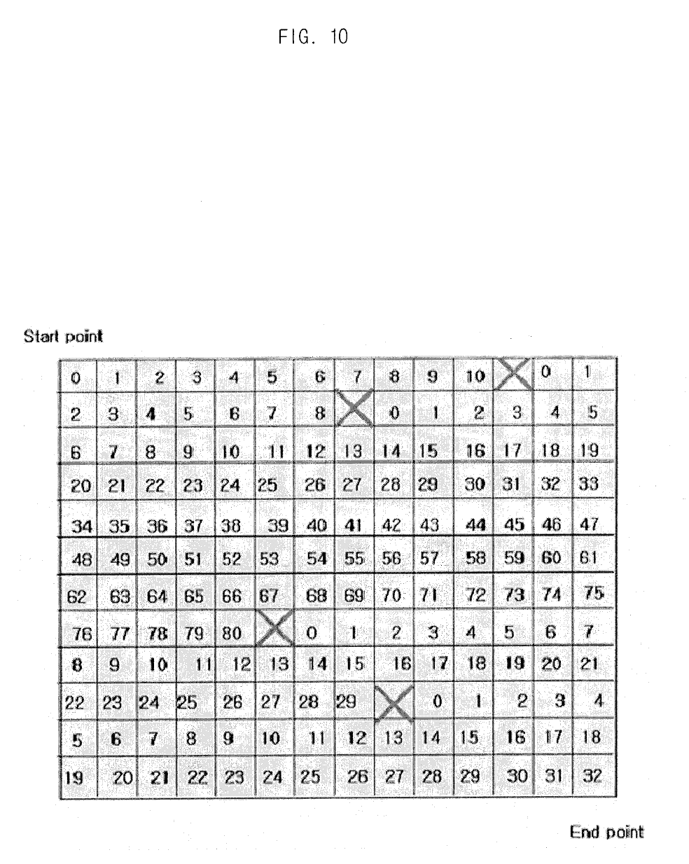

FIG. 10 illustrates a process for counting a specific window in accordance with the present invention. Referring to FIG. 10, the counter successively performs the counting from a start point of a window and renews count values to a location at which a pertinent pixel is determined as a defective pixel.

If the defective pixel is detected at a location, the location address storing unit 204 of the present invention stores a count value of the defective pixel, and the counter initializes the counter value.

Accordingly, referring to FIG. 10, in case that there are 4 defective pixels in one window, the location address storing unit 204 stores 11, 9, 81 and 30. Like this, since only order information is stored instead of location values according to horizontal and vertical directions, the location address of the defective pixel can be stored by using a smaller bit numbers than the conventional art.

After completing the detecting and counting of defective pixels pertained to all windows, the defective pixel compensating unit 206 can identify pixel data corresponding to a previously stored location address and compensate the identified pixel data by using surrounding pixel data.

The compensation of the defective pixel can be performed by various methods such as the replacing defective pixel data with its nearest pixel data and the replacing defective pixel data with the average of at least one near pixel datum.

The processor 208 can include a microcontroller (MCU) or a central processing unit (CPU). The processor 208 controls general operations of the image sensor 200, the defective pixel detecting unit 202, the location address storing unit 204 and the defective pixel compensating unit 206.

Below is described in more detail the process of storing location address through detailed structures of the image sensor 200, the defective pixel detecting unit 202 and the location address storing unit 204 in accordance with the present invention.

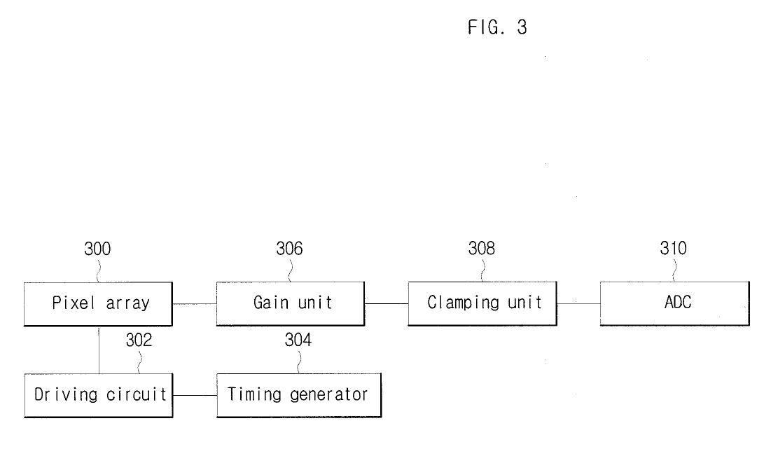

FIG. 3 is a block diagram illustrating an internal structure of an image sensor in accordance with an embodiment of the present invention. As illustrated in FIG. 3, the image sensor 200 can include a pixel array 300, a driving circuit 302, a timing generator 304, a gain unit 306, a clamping unit 308 and an analog-digital converter (ADC) 310.

As described above, the pixel array 300 is disposed with a plurality of unit pixels including photodiodes having a photoelectric transforming function. In the case of VGA, 330,000 pixels (640×480) can be included, and in the case of SVGA, 1,300,000 pixels (1280×1024) can be included.

The pixel array 300 successively outputs pixel data through a pulse outputted from the driving circuit 302. Here, the driving circuit 302 enters a pixel driving pulse into the pixel array 300 according to a pulse outputted by the timing generator 304.

The driving circuit 302 can include a row decoder, designating a row address of the pixel array 300, and a column decoder, designating a specific column address among designated low addresses. Pixel data, accumulated in each unit pixel during a predetermined exposure time, can be controlled to be outputted successively in the order of pixel line.

Through the gain unit 306, the outputted pixel data is amplified at a rate identical to or larger than a predetermined rate, and the clamping unit 308 restricts the size of the output signal in the order to prevent the problem that the size of the output signal is too increased to make the circuit stable.

The pixel data, which has passed through the gain unit 306 and the clamping unit 308, can be converted from an analog signal into a digital signal through the ADC 310. The converted digital signal is outputted into the defective pixel detecting unit 202.

Here, it is not necessary to be equipped with the ADC. In case that the defective pixel detecting unit 202 is designed to detect the defective pixel by using an analog signal, the ADC can be omitted.

The gain value of the gain unit 306 and the clamping value of the clamping unit 308 can be adjusted. The defective pixel detecting unit 202 can more exactly detect the defective pixel by bringing down an image from an unstable level to a stable level through the adjustment.

Also, the exposure time can be adjusted together to exactly detect the defective pixel.

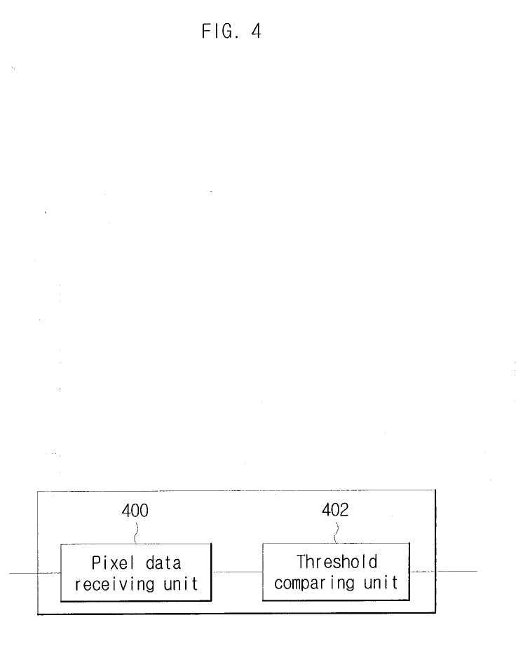

FIG. 4 is a detailed block diagram illustrating a defective pixel detecting unit in accordance with an embodiment of the present invention. As illustrated in FIG. 4, the defective pixel detecting unit 202 of the present invention can include a pixel data receiving unit 400 and a threshold comparing unit 402.

The pixel data receiving unit 400 receives pixel data related to a photographic captured in the image sensor 200 successively according to the pixel line, and threshold comparing unit 402 detects a pixel having a detect by comparing the received pixel data with a predetermined threshold.

Through the detection of the defective pixel of the present invention, a white pixel or a dead pixel is detected. The white pixel is a stuck high pixel, and the dead pixel is a stuck low pixel.

In the case of detecting the white pixel, the threshold as the comparison reference is the upper threshold. If the received data is higher than the upper threshold, the threshold comparing unit 402 determines the received pixel as the defective pixel.

In the case of detecting the black pixel, the threshold as the comparison reference is the lower threshold. If the received data is smaller than the lower threshold, the threshold comparing unit 402 determines the received pixel as the defective pixel.

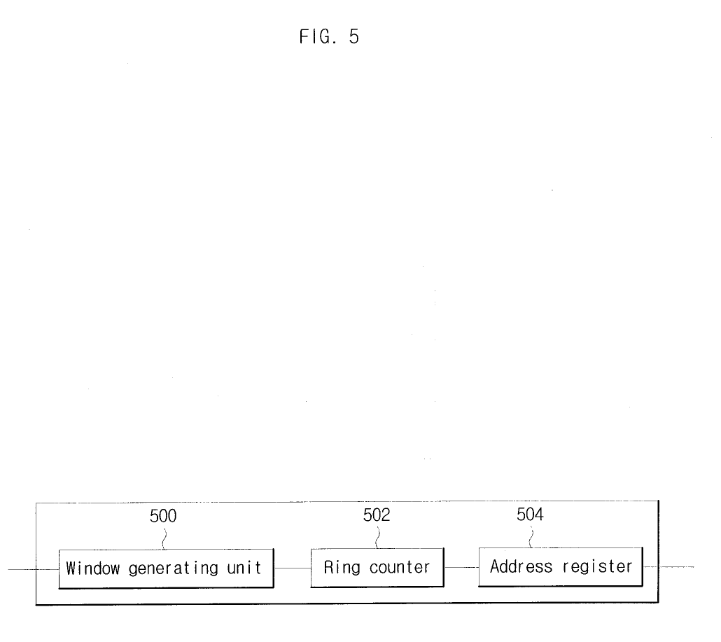

When the determination of the defective pixel is performed, and at the same time, the counting is performed by the address storing unit 204. FIG. 5 is a block diagram illustrating a location address storing unit in accordance with an embodiment of the present invention. As illustrated in FIG. 5, the location address storing unit 204 can include a window generating unit 500, a ring counter 502 and an address register 504.

The window generating unit 500 partitions the pixel array into n windows, n being a predetermined natural number.

FIG. 6 through FIG. 9 illustrate various types of windows partitioned in accordance with the present invention. As illustrated in FIG. 6 through FIG. 9, the window generating unit 500 designates at least one point (600 through 646) for a pixel array and partitions the pixel array into n windows in various forms, n being a predetermined natural number.

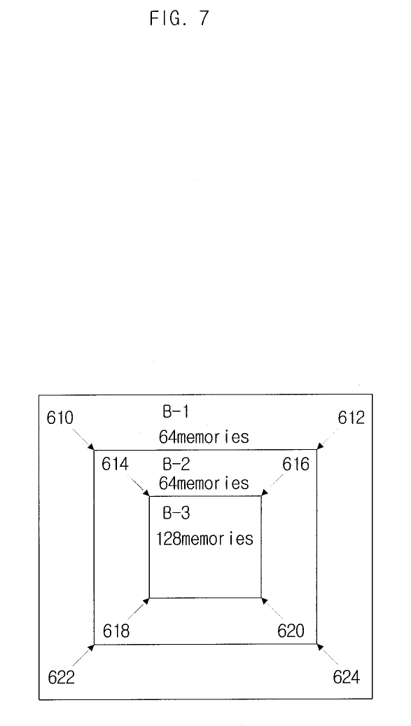

FIG. 6 illustrates that 4 points are designated and 5 windows are generated, and FIG. 7 illustrates that 8 points are designated and 3 windows are generated.

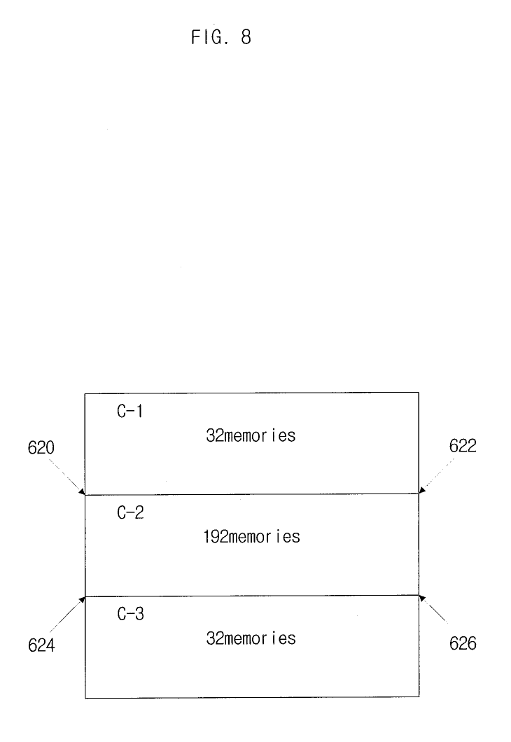

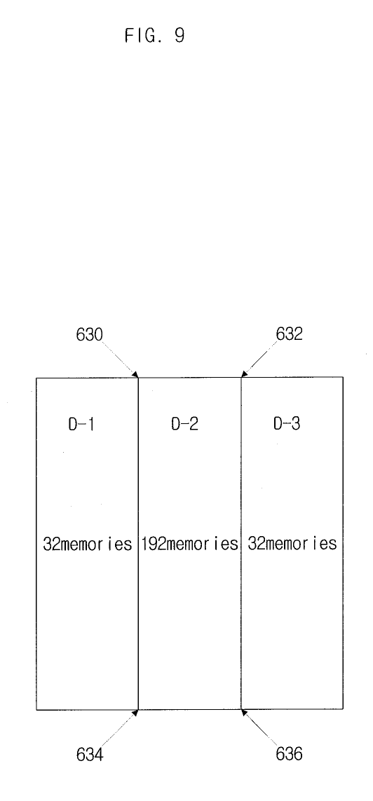

Also, FIG. 8 illustrates that 4 points are designated in a vertical direction and 3 windows are generated, FIG. 9 illustrates that 4 points are designated in a horizontal direction and 3 windows are generated

In accordance with the present invention, each window, generated as described above, can be correlated to the numbers of the storage memories allotted for each window in the address register 504.

For example, in case it is determined that the address register 504 can store addresses of 256 defective pixels in a window generated as described in FIG. 6, 128 storage memories of location addresses of defective pixels is allotted to a center window A-3, and 32 storage memories is allotted to the periphery windows A-1, A-4 and A-5, respectively, in the address register 504 of the present invention.

Here, the reason that the numbers of storage memories of relatively a lot of location addresses is allotted to a center window corresponding to the center part of the pixel array, that is, a window having the center pixel of the pixel array is that the sight lines of users are concentrated on a center part as compared with its surrounding parts.

Alternatively, although a window is generated as illustrated in FIG. 7 through FIG. 9, in accordance to the present invention, the numbers of storage memories of most location addresses is allotted to center windows B-3, C-2 and D-2 among a plurality of windows.

Although the above description explains that the address register 504 having 256 storage memories of location addresses, this description is merely an example. Alternatively, it is well-known to any person of ordinary skill in the art that the size of the address register 504 can be varied.

In the meantime, in the case of transmitting the pixel data to the defective pixel detecting unit 202 after partitioning it into n windows, n being a predetermined natural number, the ring counter 502 of the present invention generates a count value per each pixel data.

In accordance with an embodiment of the present invention, there can be provided the ring counters as many as the numbers of some windows, disposed in a horizontal direction, among a plurality of generated windows

Like this, the location address of the defective pixel pertained to each window can be efficiently stored through at least one ring counter 502. The operation of the ring counter 502 and the process for storing the location address will be described in detail with reference to FIG. 6 through FIG. 10.

In the case of FIG. 6, since the window A-1, the windows A-2 through A-4 and the window A-S, respectively, are disposed in a horizontal direction, there are provided at least three ring counters 502, and the 3 ring counter 502 independently count the receiving of the pixel data included in the windows partitioned according to the row.

Here, the windows A-2 through A-4 are disposed in a vertical direction. In this case, one counter can be shared.

As described above, the defective pixel detecting unit 202 successively receives pixel data corresponding to the pixel line of the pixel array, that is, a pixel column based on a pixel row and detects the defective pixel through the comparison with a predetermined threshold. At this time, when pixel data included in the window A-1 is received, a first ring counter corresponding to the window A-1 is activated to perform the counting. When pixel data included in the windows A-2 through A-4 is received, a corresponding second ring counter is activated to perform the counting.

At this time, the first ring counter memorizes the last count value and is on standby. After the completion of receiving pixel data corresponding to the last row, the first ring counter re-starts the counting from a count value next to the memorized count value when re-receiving the pixel data pertained to the window A-1.

FIG. 10 illustrates the counting process from a view point of one window.

FIG. 10 illustrates a process for counting a specific window in accordance with the present invention. If it is assumed that FIG. 10 illustrates the window A-I of FIG. 6, a first ring counter corresponding to a pertinent window performs the counting successively from a start point and renews a count value in the case of detecting no defective pixel.

Then, in the case of receiving pixel data determined as the defective pixel like a portion 11 at the first line of FIG. 10, a corresponding count value is stored in the address register 504.

In accordance with an embodiment of the present invention, a maximum count value (e.g. 256 in the case of 8 bits) capable of being counted by the ring counter 502 can be predetermined.

Accordingly, in the case of detecting no defective pixel in the counting process from a minimum count value to a maximum count value, the maximum count value can be stored in the address register 504. At this time, the maximum count value can be later used as information capable of identifying that the defective pixel is not detected in the portions of the window between the minimum count value and the maximum count value.

Meanwhile, the ring counter can be an 8 bit or 16 bit counter.

However, the ring counter can be provided corresponding to each window without restriction. The bit numbers of each ring counter can be variously determined by correlating to the numbers of pixels pertained to each window or the numbers of storage memories allotted for the window.

For example, the larger the size of the partitioned windows is, the more the bit numbers is increased. At this time, in case that the number of storage memories corresponding to the partitioned windows are large, the bit numbers of the ring counter of the pertinent window can be proportionally decreased according to the number of storage memories.

This is the reason why the numbers of areas covered by one ring counter can be decreased according to the increase of the numbers of the storage memories.

The location address of the defective pixel is stored. Then, the first ring counter is initialized to perform a next counting process. If pixel data next to the last row is received in the first line of FIG. 10, the first ring counter memorizes ‘1’ corresponding to the last row of the first line in the window A-1 and performs the counting in another window. Then, in the case of receiving the pixel data of the second line, re-starts the counting from a number next to the previously memorized 1.

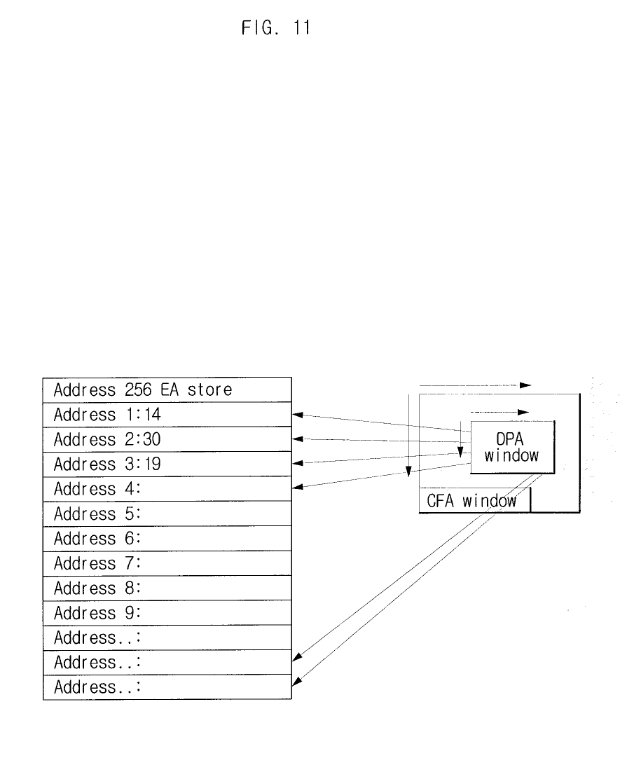

FIG. 11 illustrates a process for storing a location address of a defective pixel in a CFA window in accordance with the present invention.

As described above, in the case of detecting the defective pixel in one window, the location address storing unit 204 of the present invention successively writes count values, at the point of time when the defective pixel is detected, in an address 1, address 2, address 3, . . . . FIG. 11 illustrates that a first defective pixel is a 14^{th} pixel of the pixels included in the window, and a second defective pixel is located at a 30^{th} position from the first defective pixel.

The present invention stores the location address of the defective pixel by partitioning the pixel array into windows and independently performing a counting process of each window. Accordingly, the location address of the defective pixel of one window is stored in the address register 504 by simply allowing only order information to be stored by one counter, and it is unnecessary to store all count values in horizontal and vertical directions like the conventional art.

On the other hand, FIG. 7 illustrates that 8 points (610 through 624) are designated and 3 windows are formed in a direction away from the direction of the center. The most numbers of storage memories of location addresses are also allotted to the window B-3 including the center pixel.

In the case of generating the window as illustrated in FIG. 7, since the window can be appropriately partitioned into 3 pails, there can be provided 3 ring counters. The process of storing the count and location address is performed identically to the description related to FIG. 6.

FIG. 8 and FIG. 9 illustrate that 4 points, provided at a lower part in horizontal and vertical directions, are designated, and 3 windows are formed. Since FIG. 8 and FIG. 9 have a larger area of a center window than that of FIG. 6 and FIG. 7, a relatively larger number of storage memories of location addresses are allotted as compared with FIG. 6 and FIG. 7.

Since FIG. 9 illustrates that 3 windows is partitioned in a horizontal direction, there can be provided 3 ring counters. However, since FIG. 8 does not include windows partitioned in the horizontal direction, only one ring counter can be provided.

In the case of generating one window as illustrated FIG. 8, one ring counter can successively receive the pixel data received to the defective pixel detecting unit 202 and count the receiving of the pixel data. At this time, in the case of starting the receiving of the pixel data included in the window C-2 after all of the receiving of the pixel data included in the window C-1 is counted, the location address of the defective pixel can be allotted to be stored by initializing the earlier count value and then performing a new counting process.

On the other hand, the numbers of storage memories, allotted for each window, and window types, as illustrated in FIG. 6 through FIG. 9, are merely an example. Any person of ordinary skill in the art must understand that a user can allot the numbers of storage memories differently per each window and vary freely its forms by pre-recognizing the numbers of the defective pixels of each window in the test operating of the image processing apparatus, in accordance with the prevent invention.

In accordance with the prevent invention, the location address storing unit 204 stores the location of the defective pixel. Then, the defective pixel compensating unit 206 can compensate pixel data corresponding to the location address, stored in the address register 504, according to a predetermined algorithm.

The previously generated window and ring counter can be used in the compensation of the defective pixel. In case that the defective pixel compensating unit 206 receives the pixel data, the ring counter generates a count value of the pixel data included in each previously generated window.

The defective pixel compensating unit 206 compares a count value of the ring counter with the location address stored in the address register 504 per each window. If the count value of a specific window is identical to the location address stored for the window, the pixel data is replaced with its near pixel data or the average of its near pixel data

Since the conventional art stores the location address of the defective pixel by using two values in a horizontal and vertical direction, the defective pixel compensating unit 206 compares the two values to identify the defective data as well. However, since the present invention can compare the defective pixels by using one value through the window and the counter, for independently counting each window, the present invention can efficiently identify the defective pixel and compensate the defective pixel.

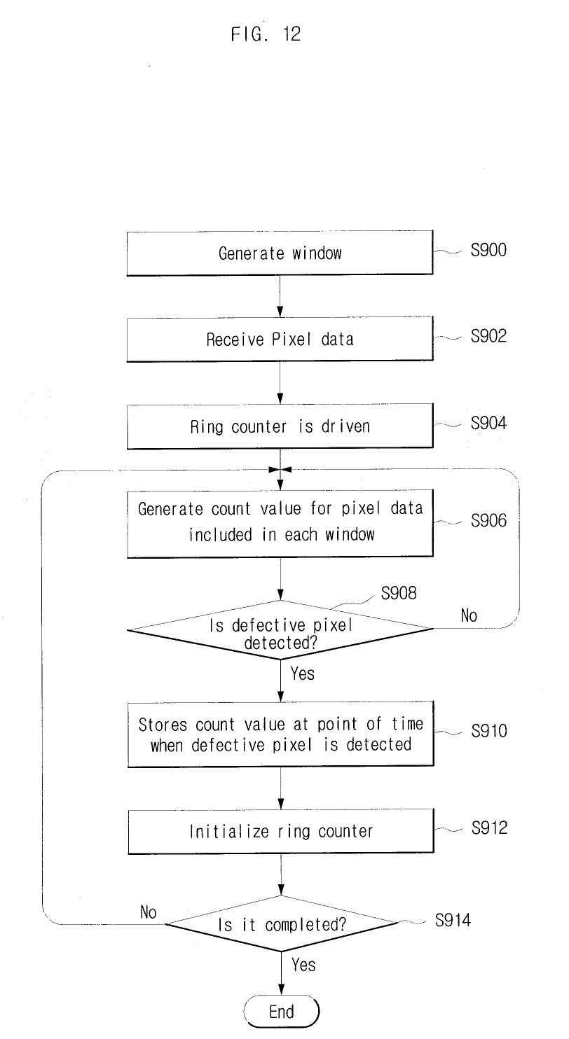

FIG. 12 is a flow chart illustrating a process for storing a location address of a defective pixel in accordance with the present invention.

Referring to FIG. 12, the window generating unit 504 of the present invention designates a point to detect the defective pixel and partitions pixel array into n windows, n being a predetermined number, in a step represented by 900.

After the window is generated, the defective pixel detecting unit 202 receives the pixel data in a step represented by 902, and at the same time, a ring counter is driven in a step represented by 904.

The ring counter generates a count value for the pixel data included in each window in a step represented by 906.

As described above, at least one ring counter of the present invention can be provided corresponding to a plurality of windows. At this time, the ring counter independently generates a count value for pixel data included in a corresponding window.

The defective pixel detecting unit 202 determines whether the pixel data received in the above step is the defective pixel, by comparing the received pixel data with a predetermined threshold in a step represented by 908.

As described above, the determining operation of the defective pixel can be performed through the comparison with an upper threshold in the case of white noise and through the comparison with a lower threshold in the case of black noise.

In the case of detecting the defective pixel in the step represented by 908, a count value of pixel data in a window corresponding to the defective pixel, at the point of time when the defective pixel is detected, is stored in the address register 504 by using the location address of the defective pixel in a step represented by 910.

Like this, after the location address of the defective pixel is stored, the ring counter is initialized to perform the counting from zero again in a step represented by 912.

Then, it is determined whether the detection of the defective pixel of the pixel array is completed in a step represented by 914. If the detection of the defective pixel is not completed, the aforementioned steps (represented 906 through 912) are repeatedly performed.

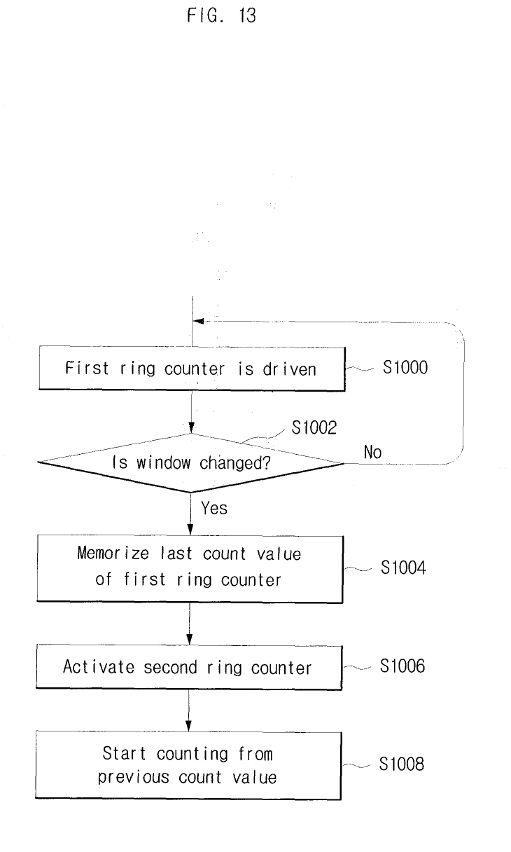

On the other hand, in accordance with the present invention, when a window is changed according to the types of the window, the counting process can be variously performed. FIG. 13 is a flow chart illustrating a counting process when a window is changed in accordance with an embodiment of the present invention.

FIG. 13 illustrates the operation of the location address storing unit in case that a pixel array is partitioned into at least one part in a vertical direction and at least one ring counter as illustrated in FIG. 6, FIG. 7 and FIG. 9. For the convenience of description, this will be described with reference to FIG. 6.

Referring to FIG. 13, in case that the defective pixel detecting unit 202 successively pixel data outputted from the pixel array, a first ring counter corresponding to a window A-1 is driven in a step represented by 1000 and determines whether a window is changed in a step represented by 1002.

It can be performed to determine whether the window is changed by checking whether pixel data included in windows A-2 through A-4 is received after the pixel data included in a window A-1.

If pixel data, next to the last pixel row of a specific line included in the window A-1, is received, a first ring counter memorizes a count value of the last row in a step represented by 1004, and at the same time, a second ring counter corresponding to a next window is activated in a step represented by 1006.

At this time, if the counting is firstly performed, the second counter performs the counting from zero. If the counting has already been performed since before, the second counter performs the counting from the previously memorized count value in a step represented by 1008.

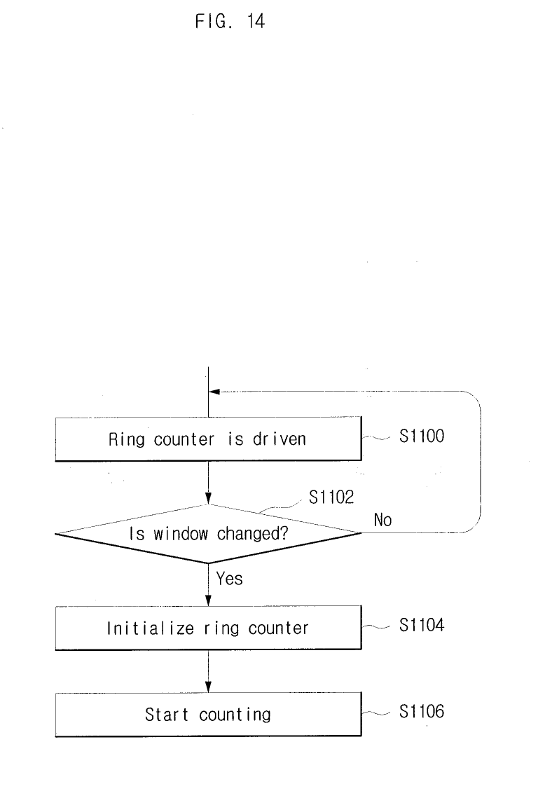

FIG. 14 is a flow chart illustrating a process for counting a location address of a defective pixel when a window is changed in accordance with another embodiment of the present invention. FIG. 14 illustrates the operation of the location address storing unit in case that there is no window partitioned in a horizontal direction as illustrated in FIG. 8.

Referring to FIG. 14, when the pixel data is received, a ring counter is driven to perform the counting in a step represented by 1100 and determines whether a window is changed in a step represented by 1102, like FIG. 13.

If it is determined that the window is changed in the step of represented by 1102, the ring counter of the present invention is initialized in a step represented by 1104. The initialized ring counter performs the counting process of the changed window in a step represented by 1106.

In other words, in the case of generating a window as illustrated in FIG. 8, the location address of the defective pixel included in each window can be stored by using only one ring counter as order information according to the ring counter.

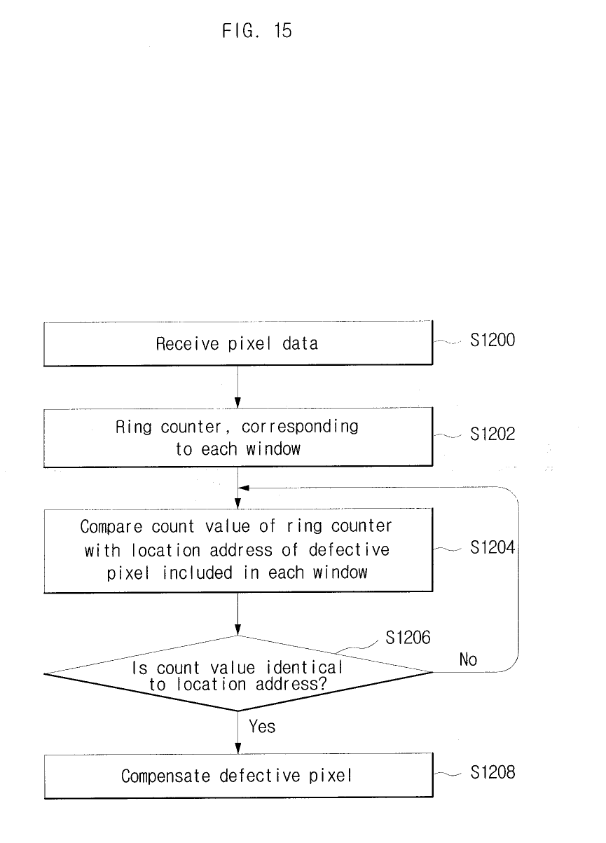

FIG. 15 is a flow chart illustrating a process of compensating a defective pixel in accordance with the present invention.

Typically, pixel data captured from the image sensor undergoes actual color conversion, gamma correction and conversion from RGB data to YUV data, through an image signal processor. The compensation of the defective pixel of the present invention can be performed before the image signal processor or can be performed by the image processor by using the location address.

Referring to FIG. 15, the defective pixel compensating unit 206 receives pixel data in a step represented by 1200. When the pixel data is received, the ring counter corresponding to each window is operated in a step represented by 1202.

The defective pixel compensating unit 206 compares the count value of the ring counter with the location address of the defective pixel previously stored for the current window in a step represented by 1204 and determines whether the count value is identical to the location address in a step represented by 1206.

At this time, since the defective pixel compensating unit 206 compares the order information of the ring counters the previously stored location address and the order information of the defective pixel of a specific window only, the defective pixel compensating unit 206 can efficiently perform a comparing operation. The defective pixel compensating unit 206 performs the compensating process of a pixel having the same count value and location address in a step represented by 1208.

The present invention can store a location address of a defective pixel by using small bit numbers because a window is generated in various forms and an independent counting process is performed in units of windows.

The present invention can decrease a manufacturing cost because it is sufficient to secure small memory size for storing a location address of a defective pixel.

The present invention can increase a compensation processing speed because a location of a defective pixel can be identified as simple information when the defective pixel is compensated.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

What is claimed is:

1. A method for storing a location address of a defective pixel of a pixel array being disposed with a plurality of unit pixels, the method comprising:
(a) partitioning the pixel array into windows in a predetermined quantity of n, n being a natural number;
(b) determining whether successively inputted pixel data is a defective pixel;
(c) storing a count value of pertinent pixel data on a window corresponding to the defective pixel as the location address if the inputted pixel data is a defective pixel; and
(d) repeating the steps (b) and (c) whenever pixel data corresponding to the pixel array is inputted,
whereas the count value of the pixel data after the location address of the defective pixel is stored is initialized.

2. The method of claim 1, wherein the number of storage memories of a location address of a defective pixel for each of the windows is pre-allotted.

3. The method of claim 2, wherein the storing size of the location address is set to the maximum for a window having a center pixel of the pixel array.

4. The method of claim 1, wherein a count value corresponding to the successively inputted pixel data in a pertinent window is generated by using each independent counter for horizontally disposed windows in a quantity of k, k being a natural number, among the windows in a quantity of n.

5. The method of claim 4, further comprising:
performing the counting by using a first counter corresponding to a first window; and
performing the counting by using a second counter corresponding to a second window if pixel data included in the second window is received,
whereas the first counter memorizes a last count value.

6. The method of claim 5, wherein the first counter starts the counting from a previously memorized count value if the pixel data included in the first window is received again.

7. The method of claim 1, wherein the windows in a quantity of n share a single counter if the windows in a quantity of n are disposed in a vertical direction.

8. The method of claim 7, further comprising:
counting the receiving of pixel data included in a first window by using the counter; and
initializing the counter and starting the counting if pixel data included in a second window is received.

9. The method of claim 1, wherein the count value is generated by using a ring counter.

10. The method of claim 1, wherein the defective pixel is determined by comparing received pixel data with a predetermined threshold.

11. The method of claim 10, wherein, if white noise is removed, the threshold is a upper threshold, and the defective pixel is determined by comparing whether the received pixel data is greater than the upper threshold.

12. The method of claim 10, wherein, if black noise is removed, the threshold is a lower threshold, and the defective pixel is determined by comparing whether the received pixel data is smaller than the lower threshold.

13. The method of claim 1, wherein the number of stored location addresses allotted for the entire windows is between 2⁸ and 2¹⁶.

14. A recorded medium tangibly embodying a program of instructions executable by a digital processing apparatus to store a location address of a defective pixel, the recorded medium being readable by the digital processing apparatus, the program comprising:
(a) partitioning a pixel array into windows in a predetermined quantity of n, n being a natural number;
(b) determining whether successively inputted pixel data is a defective pixel;
(c) storing a count value of pertinent pixel data on a window corresponding to the defective pixel as the location address if the inputted pixel data is a defective pixel; and
(d) repeating the steps (b) and (c) whenever pixel data corresponding to the pixel array is inputted,
whereas the count value of the pixel data after the location address of the defective pixel is stored is initialized.

15. A processor storing a location address of a defective pixel of a pixel array disposed with a plurality of unit pixels, the processor comprising:
a window generating unit, partitioning the plurality of unit pixels into windows in a predetermined quantity of n, n being a natural number;
counters in a quantity of j, independently counting pixel data successively inputted from the pixel array for each window, j being a natural number and 1=j=n; and
an address register, storing a count value of pertinent pixel data on a window corresponding to the defective pixel if the successively inputted pixel data is a defective pixel,
whereas the counter is initialized if the location address of the defective pixel included in the window is stored.

16. The processor of claim 15, wherein the address register is pre-allotted with the storing size of a location address of a defective pixel for each of the windows.

17. The processor of claim 15, wherein the storing size of the location address is set to the maximum for a window having a center pixel of the pixel array

18. The processor of claim 15, wherein the processor generates a count value corresponding to the pixel data in a pertinent window by using each independent counter for windows in a quantity of k, k being a natural number, if the window generating unit generates the windows in a quantity of k disposed in a horizontal direction.

19. The processor of claim 18, wherein the counter comprises a first counter, corresponding to a first window, and a second counter, corresponding to a second window adjacent to the first window,
Whereas, if pixel data included in the second window is received, the second counter is activated, and the first counter memorizes a last count value.

20. The processor of claim 19, wherein the first counter starts the counting from a previously memorized count value if the pixel data included in the first window is received again.

21. The processor of claim 15, wherein the counter is a single counter if the window generating unit generates at least one window partitioning the pixel array in a vertical direction.

22. The processor of claim 21, wherein the counter counts the receiving of pixel data included in a first window and then is initialized if pixel data included in a second window is received.

23. The processor of claim 15, wherein the counter is a ring counter.

24. An image processing apparatus, comprising:
an image sensor, having a pixel array disposed with a plurality of unit pixels;
a defective pixel detecting unit, detecting a defective pixel by using pixel data successively inputted from the image sensor;
an address storing unit, partitioning the pixel array into windows in a predetermined quantity of n, n being a natural number, storing a count value of pertinent pixel data on a window corresponding to a defective pixel as a location address if the successively inputted pixel data is the defective pixel, and initializing the count value after storing the location address of the defective pixel; and
a defective pixel compensating unit, compensating pixel data of the defective pixel based on the stored location address.

25. The apparatus of claim 24, wherein, in the case of a normal operation, the defective pixel compensating unit compares the count value of the pixel data, included in the window, with the stored location address and compensates the pixel data if the count value is identical to the location address.
